(19) United States
(12) Patent Application Publication
(10) Pub. No.: US 2010/0287596 A1
(43) Pub. Date: Nov. 11, 2010

(54) RECEIVING DEVICE

(76) Inventors: Tsuneki Yasuho, Osaka (JP); Hiroshi Aoki, Hiroshima (JP); Yasunobu Kanzaki, Hyogo (JP); Keisuke Iwata, Osaka (JP); Tsuyoshi Ide, Osaka (JP); Tatsuto Horibe, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/671,092

(22) PCT Filed: Jul. 30, 2008
(86) PCT No.: PCT/JP2008/002025

§ 371 Date: Jan. 28, 2010

(30) Foreign Application Priority Data
Aug. 3, 2007 (JP) 2007-202485

(51) Int. Cl. H04N 7/16

(52) U.S. Cl. 725/151

(57) ABSTRACT

In a power-on operation of a receiving device that receives digital broadcasting, when PIN information for setting a parental control function of a download application obtained via a network is set, a video output is turned to an off state during a time period before a download application is received from the power-on until a predetermined time elapses, a download application is executed when the download application is received during the time period from the power-on until the predetermined time elapses, and the setting of the PIN information is cancelled when a download application is not received during the time period from the power-on until the predetermined time elapses.

### TECHNICAL FIELD

The present invention relates to a receiving device for digital broadcasting such as cable broadcasting. In particular, the present invention relates to a receiving device capable of realizing various functions based on built-in applications installed in the receiving device and applications downloaded via such as the cable broadcasting.

### BACKGROUND ART

In recent years, digitalization of cable broadcasting has been promoted, and various services have been provided. Various techniques have been developed for receiving devices for such cable broadcasting. For example, Japanese Unexamined Patent Publication No. 2006-511106 discloses one of such digital cable network architectures. The OCAP (Open Cable Application Platform) has been proposed as a next-generation cable broadcasting standard specification for North America.

According to the OCAP, receiving devices such as TVs and STBs (set top boxes) can download various applications (Java (registered trademark) applications, for example) such as viewing applications for Electronic Program Guides (EPGs) and VOD (Video on Demand) from a broadcasting station. A typical receiving device realizes a predetermined function by executing a downloaded application based on the API (Application Program Interface) as set forth in the OCAP specification. In other words, the receiving device only works based on the determined API, and does not recognize a specific function that is realized by the download application. In the following, download applications that are compliant with the OCAP (Open Cable Application Platform) specification are referred to as “OCAP applications”.

The receiving device as described above checks, upon power-on, whether or not distribution of a download application and the like that is periodically transmitted from the station has been carried out, and, if a download application and the like has been distributed, executes the download application.

The receiving device holds an application that is originally installed in the receiving device (hereinafter referred to as a “built-in application”), in addition to the download application transmitted from the station. If the receiving device does not have the download application, the receiving device executes the function according to the built-in application.

Each application is provided with a parental control function which allows a user to control to turn on and off video display in case the user wishes to prevent children from viewing a harmful program. The parental control function is realized by the user setting PIN (Personal Identification Number) information. Both the built-in application and the OCAP application are provided with a function of setting the PIN information. By setting the PIN information for each application, it is possible to control the video display for the corresponding application to be turned off.

However, there is a situation that the user who uses the receiving device manages the PIN information for the built-in application and the OCAP application without knowing the PIN information for these applications are set separately. For example, the user often thinks setting the PIN information for the OCAP application makes the parental control function to work in the same way in the built-in application. In view of such a situation, manufacturers often specify the video display in the built-in application to be turned off regardless of the setting the parental control function for the built-in application when only the PIN information for the OCAP application is set.

### SUMMARY OF THE INVENTION

### Problems to be Solved by the Invention

However, with a receiving device configured as described above, when a service of an OCAP application is suspended or when moving (changing the address) to an area in which a service of the OCAP application is not offered, if PIN information for the OCAP application is set, a video image disadvantageously remains undisplayed forever because the OCAP application is not activated even after the power is turned on. The present invention is to solve such a problem, and its object is to provide a receiving device capable of executing a desired application without fail without impairing convenience to the user in a simple manner with consideration for a parental control function.

### Means for Solving the Problems

To achieve the above object, a first aspect according to the present invention provides a receiving device that receives digital broadcasting, the receiving device including:

a memory part that stores a download application obtained via a network and having a parental control function and a built-in application that is installed within the receiving device;

a PIN information holding part that holds PIN information with which the parental control function of the download application is set;

a display control part that, when PIN information with which the parental control function has been set is held in the PIN information holding part, sets a video output to an off state during a time period from power-on until a predetermined time elapses, and during which an operation is carried out based on the built-in application until the time when a download application can be received; and

a PIN information setting cancellation part that, when the PIN information with which the parental control function has been set is held in the PIN information holding part, cancels setting of the PIN information held in the PIN information holding part if a download application cannot be received during the time period from the power-on until the predetermined time elapses.

According to the receiving device of the first aspect as configured above, a problem that a video image remains undisplayed forever because the download application is not activated even after the power is turned on, when a service of the download application is suspended or when the receiving device is moved to an area in which a service of the download application is not offered is solved. With the receiving device according to the present invention, a desired application can be executed without fail without impairing convenience to the user in a simple manner with consideration for the parental control function.

In a second aspect according to the present invention, the receiving device of the first aspect is configured such that

when the PIN information with which the parental control function has been set is held in the PIN information holding part and if a download application cannot be received during the time period from the power-on until the predetermined time elapses,

the display control part displays a screen for inputting PIN information, and

the PIN information setting cancellation part cancels the setting of the PIN information held in the PIN information holding part when PIN information that is identical with the PIN information held in the PIN information holding part is inputted.

A third aspect according to the present invention provides a receiving device that receives digital broadcasting, the device including:

a memory part that stores a download application obtained via a network and having a parental control function and a built-in application that is installed within the receiving device; and

a mode selection part that selects one of a first mode and a second mode, the first mode being a mode in which, when a download application can be received, the download application is received and executed, and, when a download application cannot be received, the built-in application is executed, and the second mode being a mode in which the built-in application is executed regardless of availability of a download application.

According to the receiving device of the third aspect as configured above, regardless of the selected mode, it is possible to execute a desired application without fail with consideration for the parental control function.

In a fourth aspect according to the present invention, the receiving device of the third aspect may configured to include a PIN information holding part that holds PIN information with which the parental control function of a download application is set, wherein

when the second mode has been selected, the mode selection part displays a screen for inputting PIN information, and sets the second mode when PIN information that is identical with the PIN information held in the PIN information holding part is inputted.

A fifth aspect according to the present invention provides a receiving device that receives digital broadcasting, the device including:

a memory part that stores a download application obtained via a network and having a parental control function and a built-in application that is installed within the receiving device;

a PIN information holding part that holds PIN information with which the parental control function of a download application is set;

a display control part that, when PIN information with which the parental control function has been set is held in the PIN information holding part, sets a video output to an off state during a time period from power-on until the time when a download application can be received during which an operation is carried out based on the built-in application;

a cable card interface part to which a cable card is detachably attached and that reads a content of a memory area of the cable card; and

a cable card management part that carries out an authenticating operation of the cable card, wherein

the cable card management part cancels, when the cable card is determined to be different from a cable card that has been authenticated last time in the authenticating operation, setting of the PIN information that is held in the PIN information holding part.

According to the receiving device of the fifth aspect as configured above, when using the cable card, it is possible to execute a desired application without fail with consideration for the parental control function.

A sixth aspect according to the present invention provides a receiving program stored in a receiving device that receives digital broadcasting, the program causes a computer to realize:

a function for detecting, in a power-on operation, setting of PIN information with which a parental control function of a download application obtained via a network is set;

a function for, when the PIN information is set, setting a video output to an off state during a time period from the power-on until a predetermined time elapses until the time when a download application can be received;

a function for, when the PIN information is set and if a download application is received during the time period from the power-on until the predetermined time elapses, executing the download application; and

a function for canceling the setting of the PIN information when the PIN information is set and if a download application is not received during the time period from the power-on until the predetermined time elapses.

According to the receiving program of the sixth aspect as configured above, a problem that a video image remains undisplayed forever because the download application is not activated even after the power is turned on, when a service of the download application is suspended or when the receiving device is moved to an area in which a service of the download application is not offered is solved. With the receiving program according to the present invention, a desired application can be executed without fail without impairing convenience to the user in a simple manner with consideration for the parental control function.

In seventh aspect of the receiving program according to the present invention, the function for canceling the setting of the PIN information of the sixth aspect may include:

a function for displaying a screen for inputting PIN information;

a function for verifying whether or not PIN information that is inputted is identical with PIN information that has previously been set;

a function for unlocking the PIN information if the inputted PIN information is identical with the PIN information that has previously been set, and turning the video output to an on state; and

a function for displaying the screen for inputting PIN information again if the inputted PIN information is different from the PIN information that has previously been set.

An eighth aspect according to the present invention provides a receiving program stored in a receiving device that receives digital broadcasting, the program causes a computer to realize:

a function for storing, in a memory part, a download application obtained via a network and having a parental control function and a built-in application that is installed within the receiving device;

a function for displaying a screen for selecting one of a first mode and a second mode,

the first mode being a mode in which, when a download application can be received, the download application is received and executed, and, when a download application cannot be received, the built-in application is executed, and the second mode being a mode in which the built-in application is executed regardless whether a download application can be received or not;

a function for executing the first mode when the first mode has been selected;

a function for displaying a screen for inputting PIN information with which the parental control function of a download application is set when the second mode has been selected;

a function for verifying whether or not PIN information that is inputted is identical with PIN information that has previously been set;

a function for executing the second mode if the inputted PIN information is identical with the PIN information that has previously been set; and

a function for displaying the screen for selecting the mode again if the inputted PIN information is different from the PIN information that has previously been set.

According to the receiving program of the eighth aspect of the present invention as configured above, regardless of the selected mode, a desired application can be executed without fail without impairing convenience to the user in a simple manner with consideration for the parental control function.

A ninth aspect according to the present invention provides a receiving program stored in a receiving device that receives digital broadcasting, the program causes a computer to realize:

a function for storing, in a memory part, a download application obtained via a network and having a parental control function and a built-in application that is installed within the receiving device;

a function for managing one of a first mode and a second mode,

the first mode being a mode in which, when a download application can be received, the download application is received and executed, and, when a download application cannot be received, the built-in application is executed, and

the second mode being a mode in which the built-in application is executed regardless whether a download application can be received or not;

a function for detecting, in a power-on operation, setting of PIN information with which a parental control function of a download application is set when the first mode is managed;

a function for, when the PIN information is set, setting a video output to an off state during a time period from the power-on until a predetermined time elapses until the time when a download application can be received;

a function for, when the PIN information is set and if a download application is received during the time period from the power-on until the predetermined time elapses, executing the download application;

a function for canceling the setting of the PIN information when the PIN information is set and if a download application is not received during the time period from the power-on until the predetermined time elapses; and

a function for executing the built-in application when the second mode is managed in the power-on operation.

According to the receiving program of the ninth aspect of the present invention as configured above, regardless of the selected mode, a desired application can be executed without fail without impairing convenience to the user in a simple manner with consideration for the parental control function.

In tenth aspect of the receiving program according to the present invention, the receiving program of the ninth aspect may include:

when the first mode is managed in the power-on operation and when the PIN information for a download application is not set,

a function for, when a download application is received during the time period from the power-on until the predetermined time elapses, executing the download application; and

a function for executing the built-in application when a download application is not received during the time period from the power-on until the predetermined time elapses.

An eleventh aspect according to the present invention provides receiving program stored in a receiving device that receives digital broadcasting, the program causes a computer to realize:

a function for storing, in a memory part, a download application obtained via a network and having a parental control function and a built-in application that is installed within the receiving device;

a function for exchanging an authentication key managed in the receiving device and an authentication key recorded in a detachable card, and for detecting whether or not the authentication keys are identical to each other;

a function for exchanging certification of the receiving device and certification of the card and authenticating each other when the authentication key of the receiving device and the authentication key of the card are not identical;

a function for generating new authentication keys based on contents of both the certification of the receiving device and the card;

a function for recording the newly generated authentication keys respectively in corresponding memory areas of the receiving device and the card;

a function for canceling setting of PIN information with which the parental control function of the download application is set after the newly generated authentication keys are recorded in the receiving device and the card; and

a function for terminating an operation of authenticating the card by the receiving device when the authentication key of the receiving device and the authentication key of the card are identical and when the setting of PIN information is canceled.

According to the receiving program of the eleventh aspect as configured above, when using the cable card, it is possible to execute a desired application without fail with consideration for the parental control function.

The novel characteristics of the present invention are neither more nor less than what is specifically described in the scope of the claims, and reading the following detailed description along with other objects and feature with reference to the drawings will provide better understanding and evaluation of the present invention regarding its configuration and content.

### Effects of the Invention

According to the present invention, with a receiving device in which PIN information for a download application, for example, an OCAP application, is set, a problem that a video image remains undisplayed forever because a download application is not activated even after the power is turned on when a service of the download application is suspended or when moving to an area in which a service of the download application is not offered is solved without impairing convenience to the user in a simple manner with consideration for the parental control function.

### BRIEF DESCRIPTION OF THE DRAWINGS

FIG. 1 is a block diagram illustrating a hardware configuration of a receiving device for cable broadcasting of a first embodiment according to the present invention.

FIG. 2 is a schematic diagram illustrating a composite configuration and an output configuration of planes in a composing part of the receiving device for cable broadcasting of the first embodiment.

FIG. 3A is a schematic diagram illustrating how a composite plane is viewed by viewers when the composite plane is outputted to a display of the receiving device for cable broadcasting of the first embodiment.

FIG. 3B is a schematic diagram illustrating how a composite plane is viewed by viewers when the composite plane is outputted to an external video recording device relating to the receiving device for cable broadcasting of the first embodiment.

FIG. 4 is a schematic diagram illustrating a composite configuration and an output configuration of a dedicated plane for an OCAP application with other planes when the plane for the OCAP application is used in a composing part of the receiving device for cable broadcasting of the first embodiment.

FIG. 5A is a schematic diagram illustrating positional relation between planes when the planes are outputted from the composing part to the display in FIG. 4 such that the plane for the OCAP application comes at a top surface which is at a position closest to the viewer.

FIG. 5B is a schematic diagram illustrating positional relation between planes when the planes are outputted from the composing part to the external video recording device in FIG. 4.

FIG. 6 is a block diagram illustrating a functional configuration of the receiving device for cable broadcasting of the first embodiment.

FIG. 7 is a flow chart showing a process of the receiving device for cable broadcasting of the first embodiment during a power-on operation (during an on operation).

FIG. 8 is a flow chart showing a process of the receiving device for cable broadcasting of the first embodiment during an operation of canceling PIN information setting.

FIG. 9 is a chart showing service modes specified for the receiving device for cable broadcasting of a second embodiment according to the present invention.

FIG. 10 is a flow chart showing an operation of selecting a service mode of the receiving device for cable broadcasting of the second embodiment.

FIG. 11 is a flow chart showing a process of the receiving device for cable broadcasting of the second embodiment during a power-on operation.

FIG. 12 is a flow chart showing a process of the receiving device for cable broadcasting of the second embodiment during the power-on operation.

FIG. 13 is a flow chart showing an operation of the receiving device for cable broadcasting of a third embodiment according to the present invention when a cable card is inserted.

### DETAILED DESCRIPTION OF PREFERRED EMBODIMENTS

A description will be given of preferred embodiments of a receiving device and a receiving program held in the receiving device according to the present invention with reference to the attached drawing. It should be understood that the present invention is not limited to configurations that are described relating to the following embodiments, and can include other configurations based on the same technical idea.

### First Embodiment

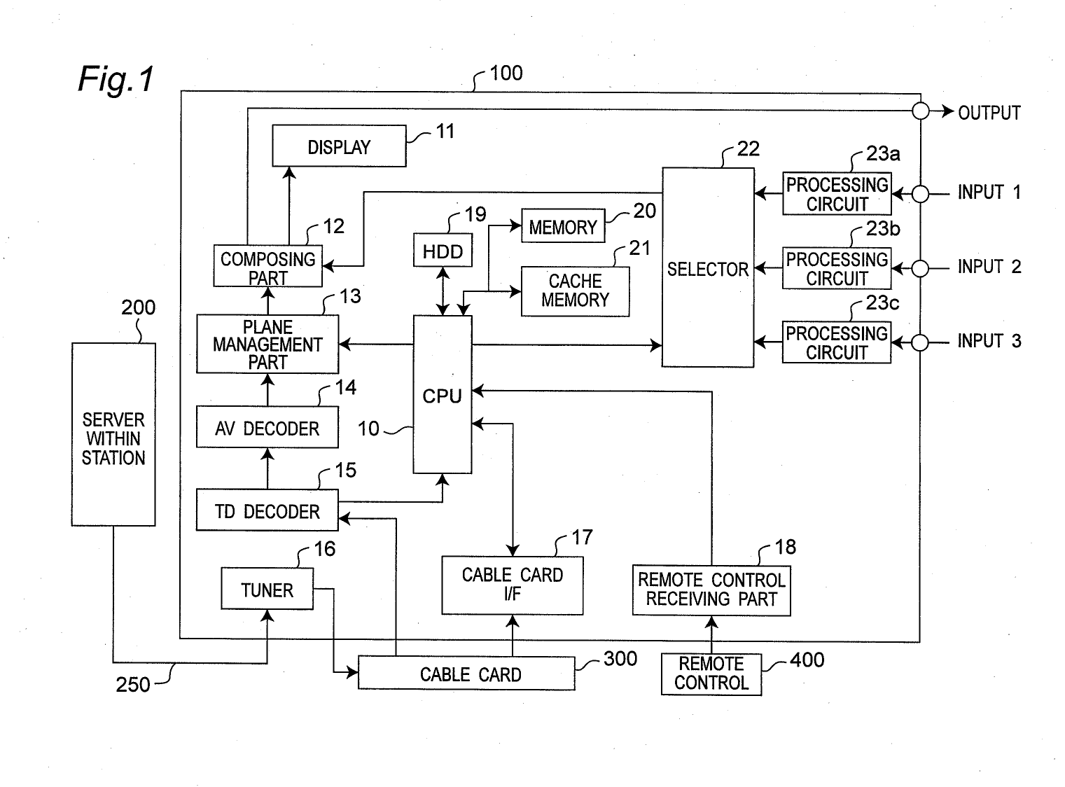

The receiving device of a first embodiment according to the present invention is a receiving device for cable broadcasting and a receiving device for digital broadcasting. FIG. 1 is a block diagram illustrating a hardware configuration of a cable broadcasting receiving device 100 of first embodiment according to the present invention. The cable broadcasting receiving device 100 is connected via a cable 250 with a station server 200 that is placed in a cable broadcasting station and provides cable broadcasting. The cable broadcasting receiving device 100 is inserted with a cable card 300 for receiving cable broadcasting from a specific cable broadcasting station and configured to receive cable broadcasting by carrying out a predetermined process. Further, the cable broadcasting receiving device 100 receives user operation information (key code) via a remote control 400 operated by a user, and carries out a process corresponding to the received key code. Moreover, the cable broadcasting receiving device 100 includes an output system (output) for outputting a video audio signal to an external video recording device such as a DVD, and video audio signal input systems (input 1, input 2, and input 3) for inputting a plurality of pieces of video audio information in addition to a piece of information from the cable broadcasting station. Here, the cable broadcasting receiving device 100 of the first embodiment is a device capable of receiving cable broadcasting compliant with the OCAP specification. In the hardware configuration shown in the block diagram of FIG. 1, a configuration for processing the audio signal is not shown in order to simplify the explanation.

The cable broadcasting receiving device 100 is provided with a CPU 10, a display 11, a composing part 12, a plane management part 13, an AV decoder 14, a TD decoder 15, a tuner 16, a cable card interface (hereinafter abbreviated as a cable card I/F) 17, a remote control receiving part 18, a hard disk drive (HDD) 19, a memory 20, a cache memory 21, a selector 22, and processing circuits 23a-23c.

The CPU 10 is a controller that controls operations of the cable broadcasting receiving device 100. The CPU 10 is connected with the HDD 19 as memory means for data, the memory 20 that is volatile memory means, and the cache memory 21 that is nonvolatile memory means. Further, the CPU 10 displays, based on the key code inputted from the remote control receiving part 18, one of the pieces of information inputted from any of the cable broadcasting and the inputs 1-3 on the display 11.

The display 11 displays a video outputted from the composing part 12. The composing part 12 composes a plurality of planes outputted from the plane management part 13, and carries out an output to the display 11 or to the external video recording device. Here, a plane indicates pixel data (Pixel Map) for a single screen recorded in a memory area.

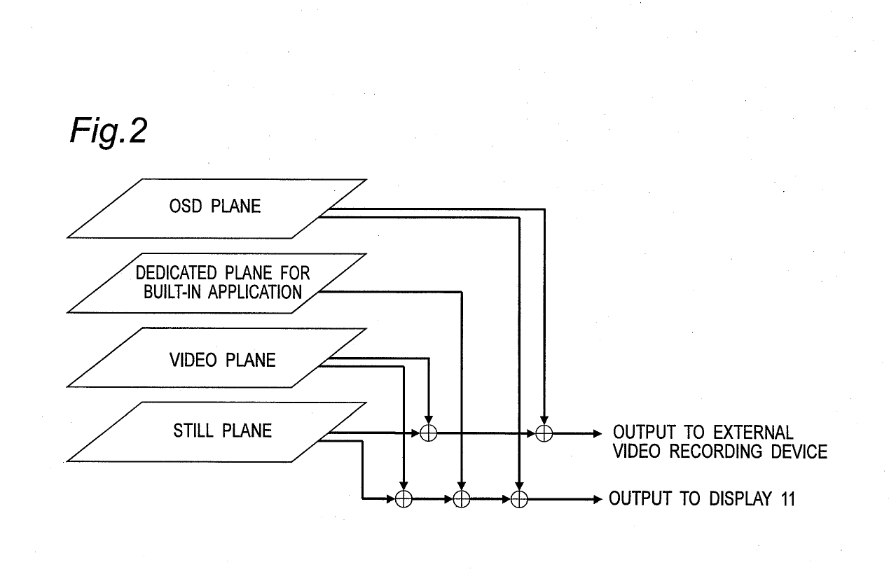

FIG. 2 is a schematic diagram illustrating a composite configuration and an output configuration of the planes that are composed by the composing part 12. As shown in FIG. 2, the composing part 12 composes a still plane, a video plane, a dedicated plane for the built-in application, and an OSD (On Screen Display) plane outputted from the plane management part 13, and outputs the composed planes to the display 11 or the external video recording device. Here, the still plane indicates pixel data (Pixel Map) of a still image for a single screen recorded in the memory area relating to an image that the OCAP application uses as a background image. The video plane indicates pixel data (Pixel Map) for a single screen recorded in the memory area relating to a video image. The dedicated plane for the built-in application indicates pixel data (Pixel Map) for a single screen recorded in the memory area relating to OSD information of the built-in application. The OSD plane indicates pixel data (Pixel Map) for a single screen recorded in the memory area relating to OSD information used by the OCAP application.

In addition, the composing part 12 has a function such that, based on control of the CPU 10, information is inputted to the composing part 12 via one of the inputs 1-3 selected by the selector 22, and outputted to the display 11.

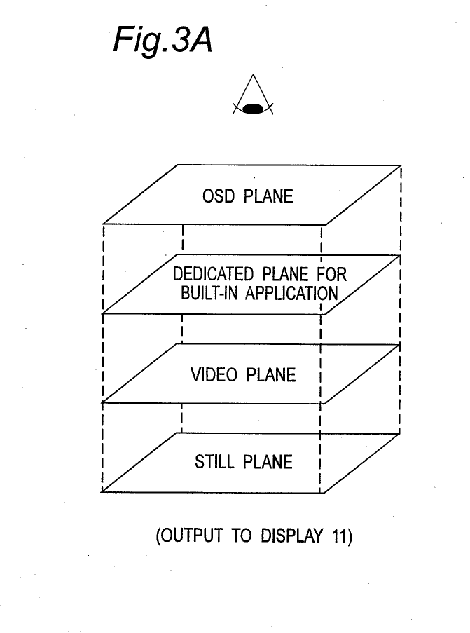

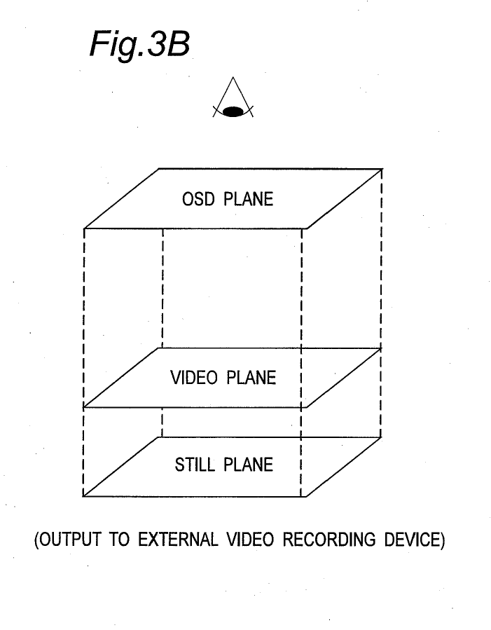

FIG. 3A and FIG. 3B are schematic diagrams illustrating a way in which a viewer who is a user of the planes that are composed by the composing part 12 sees, and respectively represent a state in which the viewer sees the planes that are layered from the above. FIG. 3A shows a case in which the composite plane is outputted from the composing part 12 to the display 11, and FIG. 3B shows a case in which the composite plane is outputted from the composing part 12 to the external video recording device.

When the composing part 12 outputs the composite plane to the display 11 as shown in FIG. 3A, the still plane, the video plane, the dedicated plane for the built-in application, and the OSD plane are composed and outputted according to an operational state of the built-in application and the OCAP application. Further, when the composing part 12 outputs the composite plane to the external video recording device as shown in FIG. 3B, the still plane, the video plane, and the OSD plane are composed and outputted. Therefore, the dedicated plane for the built-in application is not included in the planes outputted to the external video recording device.

There is a case that a dedicated plane for the OCAP application is included as one of the planes that are composed by the composing part 12. The dedicated plane for the OCAP application indicates pixel data (Pixel Map) for a single screen recorded in a memory area relating to OSD information that the OCAP application does not wish to output to the external video recording device.

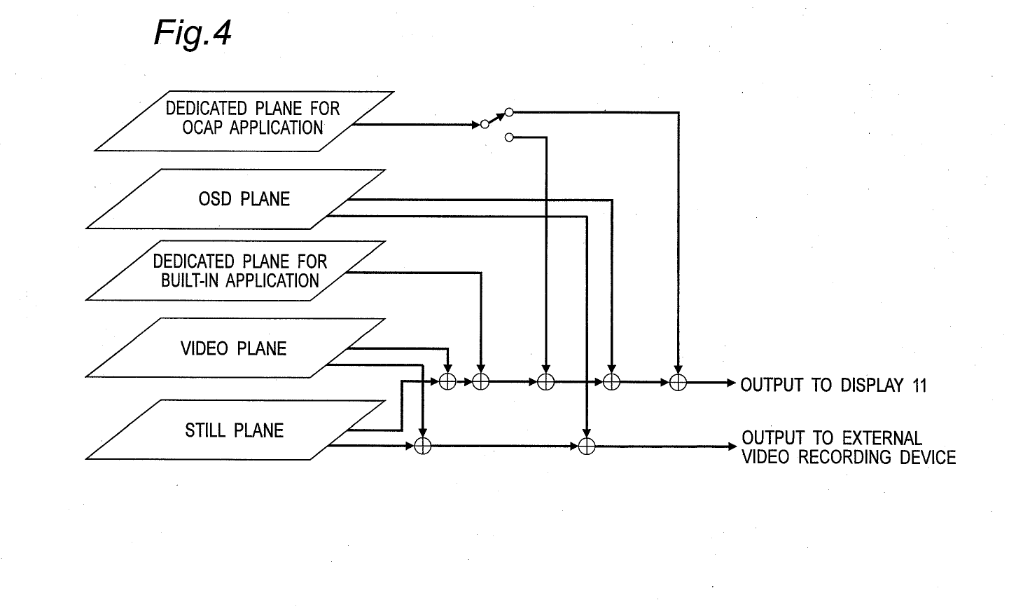

FIG. 4 is a schematic diagram illustrating a composite configuration and an output configuration of the dedicated plane for the OCAP application with other planes when the dedicated plane for the OCAP application is used by the composing part 12. When the composing part 12 uses the dedicated plane for the OCAP application as shown in FIG. 4, the composing part 12 can provide the dedicated plane for the OCAP application either at a top surface that is closest to the viewer or between the dedicated plane for the built-in application and the OSD plane. This selection may be determined based on the operational state of the built-in application and the OCAP application, as well as on a content of the dedicated plane for the OCAP application.

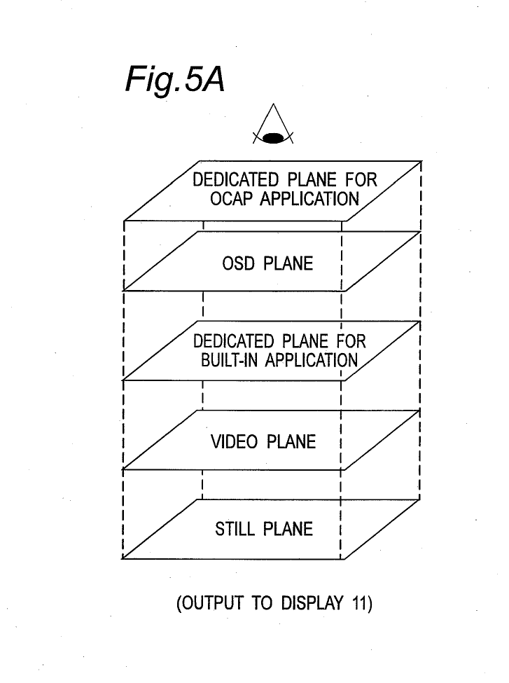

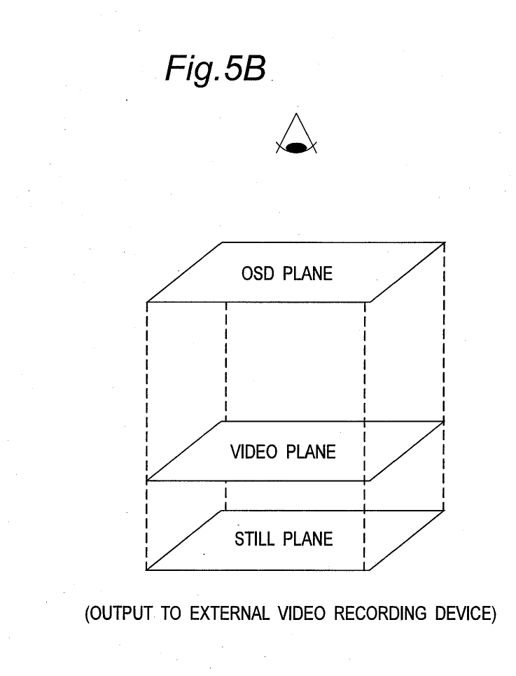

FIG. 5A shows positional relation between the planes that are composed, when the planes are outputted from the composing part 12 to the display 11 in FIG. 4 such that the plane for the OCAP application comes at the top surface which is the closest position to the viewer. FIG. 5B shows positional relation between the planes that are composed when the planes are outputted from the composing part 12 to the external video recording device in FIG. 4. FIG. 5A and FIG. 5B are schematic diagrams showing a state in which the viewer sees the planes from the above. Therefore, the dedicated plane for the built-in application and the dedicated plane for the OCAP application are not included in the planes outputted to the external video recording device.

As described above, the plane management part 13 outputs the still plane, the video plane, the dedicated plane for the built-in application, the OSD plane, and the dedicated plane for the OCAP application to the composing part 12 and manages these planes.

As shown in FIG. 1, the AV decoder 14 provided for the cable broadcasting receiving device 100 decodes audio/video image data that has been distributed from the station server 200 in a format such as MPEG. The TD decoder 15 converts a transport stream generated by multiplexing audio/video image/data by packet filtering and outputs each data individually (Demultiplexing). The tuner 16 receives a signal that has been distributed from the station server 200 via the cable 250. The received signal is descrambled by the cable card 300 and outputted to the TD decoder 15.

The cable card I/F 17 performs transmission and reception of data with the cable card 300. The remote control receiving part 18 receives user operation information (key code) from the remote control 400 operated by the user, and outputs the information as a key code to the CPU 10.

The selector 22 selects one of outputs from the processing circuits 23a-23c, and outputs the selected output to the composing part 12. The processing circuits 23a-23c processes video audio signals respectively inputted from three inputs (input 1, input 2, and input 3), for example, as input systems, and inputs the processed signals to the selector 22.

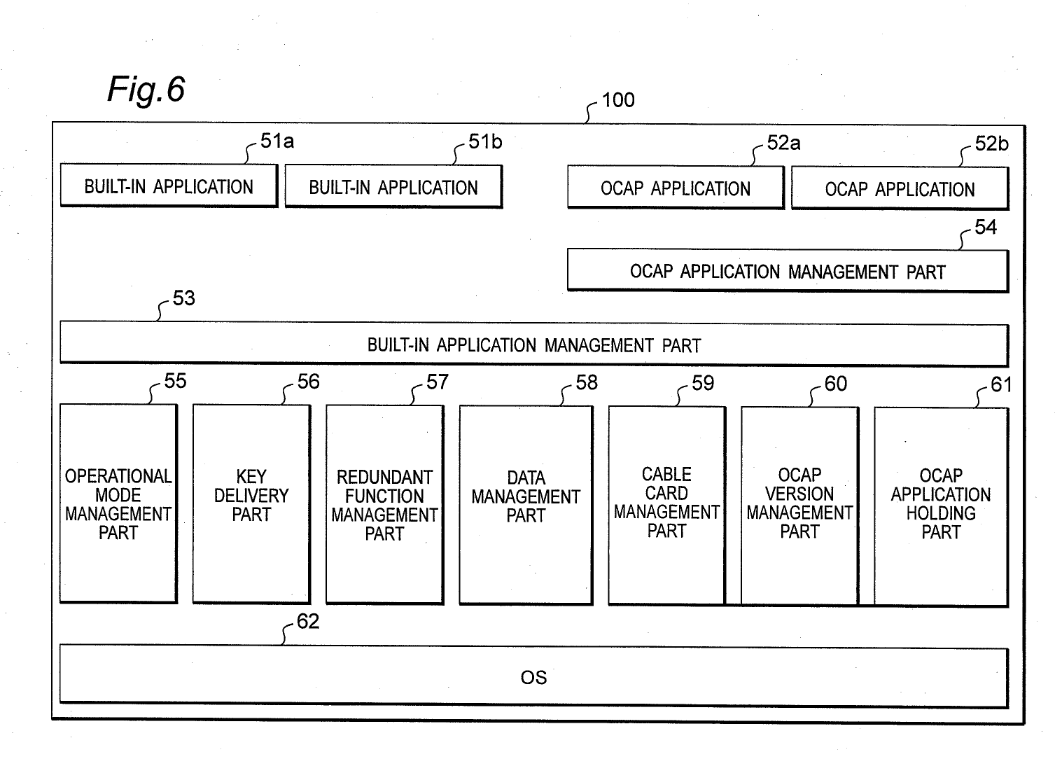

Next, referring to FIG. 6, a functional configuration of the cable broadcasting receiving device 100 of the first embodiment will be described. FIG. 6 is a block diagram illustrating the functional configuration of the cable broadcasting receiving device 100 of the first embodiment.

The functional configuration shown in the block diagram of FIG. 6 is realized by the CPU 10 (see FIG. 1) executing a predetermined program. In FIG. 6, major functions for the present invention are shown for sake of simplicity of explanation. A function of the cable broadcasting receiving device 100 as will be later described can be realized by the CPU 10 executing a predetermined program even if the function is not shown in FIG. 6.

The cable broadcasting receiving device 100 is provided with built-in applications 51a, 51b, OCAP applications 52a, 52b, a built-in application management part 53, an OCAP application management part 54, an operational mode management part 55, a key delivery part 56, a redundant function management part 57, a data management part 58, a cable card management part 59, an OCAP version management part 60, an OCAP application holding part 61, and an OS 62.

The built-in applications 51a, 51b of the cable broadcasting receiving device 100 include such as a channel selection application, a parental control display application, and a setup application, for example, and these applications are either installed in the cable broadcasting receiving device 100 before shipping, or installed via a network or through a storage medium such as an SD card. The OCAP applications 52a, 52b include such as a channel selection application, a parental control display application, and a setup application, for example, and these applications are obtained by downloading from the station server 200 and the like.

The built-in application management part 53 controls activation of the built-in applications 51a, 51b, delivery control of the key code of the built-in applications 51a, 51b, and activation of the OCAP application management part 54. The OCAP application management part 54 is middleware that executes the OCAP applications 52a, 52b, and controls activation of the OCAP applications 52a, 52b and delivery control of the key code of the OCAP applications 52a, 52b.

The operational mode management part 55 manages operational modes of the cable broadcasting receiving device 100. The operational modes include an IDTV mode and an OCAP mode. The IDTV mode indicates a state in which only the built-in applications 51a, 51b are operated. The OCAP mode indicates a state in which the OCAP applications 52a, 52b are also operated. Further, the operational mode management part 55 manages conditions of the built-in applications 51a, 51b, as well as the activation and termination of the OCAP applications 52a, 52b notified by the OCAP application management part 54.

The key delivery part 56 delivers the key code from the remote control 400 (see FIG. 1) either to the built-in application management part 53 or to the OCAP application management part 54.

The redundant function management part 57 carries out determination of exclusion or sharing of the built-in applications 51a, 51b and the OCAP applications 52a, 52b based on exclusion/sharing information that has been previously set. As used herein, the exclusion/sharing information refers to information that describes, regarding similar functions that are carried out by the both applications, priorities between the OCAP mode and the IDTV mode for each function.

The data management part 58 manages data such as PIN (Personal Identification Number) information, parental information, subtitle setting information, for example, that is shared by both of the built-in applications (51a, 51b) and the OCAP applications (52a, 52b). The cable card management part 59 is a module that receives, manages, and executes a request from a card, for example, the cable card 300 (see FIG. 1).

The OCAP version management part 60 manages versions of the OCAP applications 52a, 52b held in the OCAP application holding part 61, as well as carries out a version-up processing of the OCAP applications 52a, 52b based on XAIT (Extended Application Information Table) that has been received. As used herein, the XAIT refers to management information of the OCAP applications 52a, 52b transmitted from the station server 200, and includes at least version information and stored location (such as URL information) of the OCAP applications 52a, 52b as information of the OCAP applications 52a, 52b to be activated. The cable broadcasting receiving device 100 receives the XAIT periodically from the station server 200. The OCAP application holding part 61 holds the OCAP applications 52a, 52b downloaded from the station server 200 based on the XAIT. The OS 62 is software that manages the cable broadcasting receiving device 100 as a whole.

Next, an operation of the cable broadcasting receiving device of the first embodiment according to the present invention will be described.

[Video Output Operation When Turning Power-on]

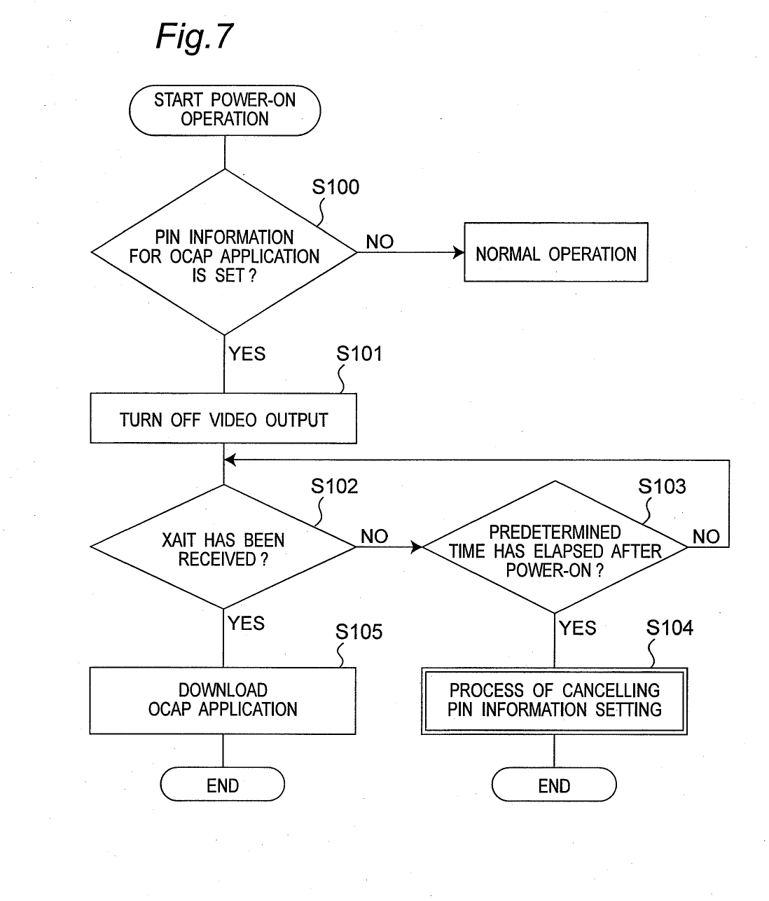

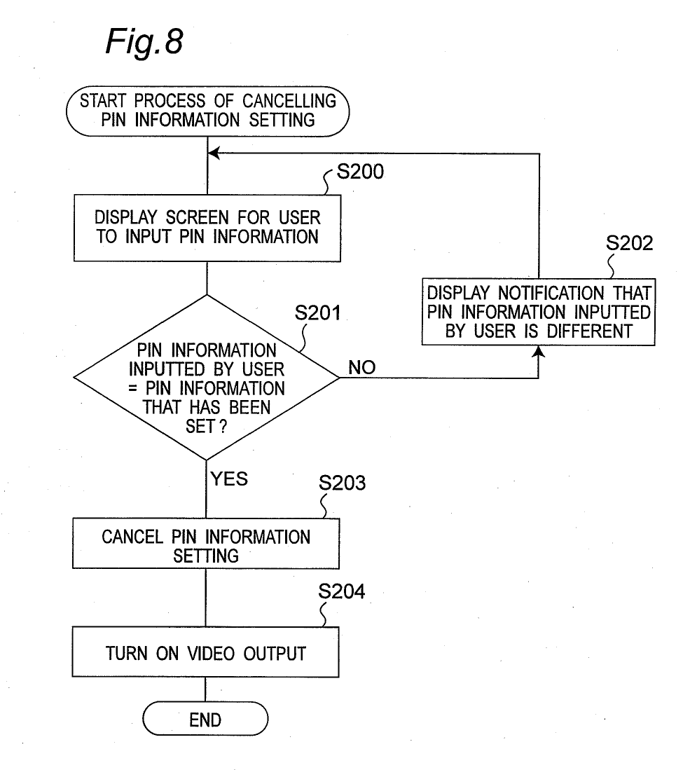

A description will be given of an operation of the cable broadcasting receiving device 100 of the first embodiment having a configuration as described above after the power is turned on (on state) with reference to flowcharts shown in FIG. 7 and FIG. 8. FIG. 7 is the flow chart showing a process of a power-on operation (on operation). FIG. 8 is the flow chart showing a process of canceling PIN information setting.

When the power is turned on, confirmation to the data management part 58 on whether PIN information for the OCAP application is set or not is made (S100). If the PIN information is set, the video output is turned to an off state (S101). Specifically, the dedicated plane for the built-in application is blacked out, and only the video output from the OSD plane is displayed (see FIG. 3A). As an operation when the PIN information is not set is a normal operation for video output and is not directly related to the present invention, an explanation for the operation is omitted herein.

After the video output is turned to the off state in S101, it is then determined whether the XAIT has been received or not (S102). As described above, the XAIT is periodically distributed from the station server 200. The fact that the XAIT has been received means that the cable broadcasting receiving device 100 can download the OCAP application and operate. On the other hand, when the XAIT cannot be received, it is confirmed, in S103, whether or not a predetermined time period has elapsed since the power-on (for example, 10 seconds). If the predetermined time period has not elapsed, whether or not the XAIT has been received is again confirmed (proceeding to S102). If the XAIT cannot be received even after the predetermined time period has elapsed since the power-on, this means that an OCAP service is not offered in this area. As the video output cannot be turned on in such a situation, the process of canceling the PIN information setting is carried out (S104). This canceling operation of the PIN information setting will be later described.

When it is confirmed that the XAIT has been received in S102, the OCAP application is downloaded (S105). As it takes more or less time to complete downloading the OCAP application, a text such as “Obtaining OCAP”, for example, is written to the OSD plane in consideration for the user, and the display 11 is caused to output a video image. The output of the text “Obtaining OCAP” is deleted either when obtaining “Service Context” defined by the OCAP specification is completed, when the OSD plane is turned to a visible state from an invisible state, when loading of “Xlet” defined by he OCAP specification is completed, when processing “intXlet”, or when processing “startXlet”. The cable broadcasting receiving device 100 of the first embodiment is operated according to the OCAP application after the OCAP application is downloaded as described above.

A description will be given of the canceling operation of the PIN information setting carried out in S104 of FIG. 7 with reference to FIG. 8.

In S200 of FIG. 8, a screen that prompts the user to input PIN information is displayed on the display 11. It is confirmed whether or not the PIN information inputted by the user is identical with the PIN information for the OCAP application held in the data management part 58 (S201). If the PIN information inputted by the user is different from the PIN information for the OCAP application held in the data management part 58, a text such as “PIN number is not correct”, for example, is displayed (S202), and the screen to prompt the user to input PIN information is again displayed on the display 11 (proceeding to S200).

In S201, if the PIN information inputted by the user is identical with the PIN information for the OCAP application held in the data management part 58, the PIN information for the OCAP application held in the data management part 58 is unlocked (S203). Along with the unlocking of the PIN information, the black out of the plane for the built-in application is also lifted (S204). As a result, the video image is outputted in the cable broadcasting receiving device 100 of the first embodiment.

While the video output is controlled by causing the plane for the built-in application to be blacked out in the above description of the first embodiment, the video output of the cable broadcasting receiving device may be controlled by such a manner that only the video image from the OSD plane is outputted and displayed without outputting the video images from the video plane and the still plane.

In this manner, with the receiving device of the first embodiment, if the PIN information for the OCAP application is set, a problem that, when the service of the OCAP application is suspended or when the user has moved to an area in which the service of the OCAP application is not offered, the video image forever remains undisplayed because the OCAP application is not activated after the power is turned on is solved. As described above, the receiving device of the first embodiment offers convenience to the user in a simple manner with consideration for the parental control function.

### Second Embodiment

A description will be given of a cable broadcasting receiving device of a second embodiment according to the present invention. The cable broadcasting receiving device of the second embodiment is configured to allow selection of a service mode. A hardware configuration and a basic functional configuration of the cable broadcasting receiving device of the second embodiment are the same as shown in FIG. 1 and FIG. 6 described above with reference to the first embodiment.

[Selecting Operation of Service Mode]

A description will be given of a selecting operation of the service mode in the cable broadcasting receiving device of the second embodiment.

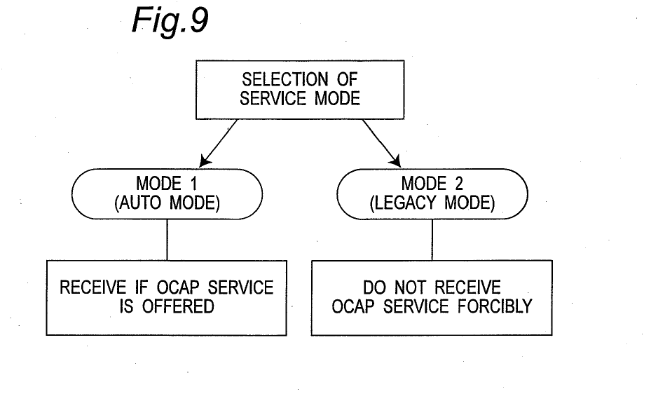

The service mode is a selective mode regarding which one of the applications such as the OCAP applications and the built-in applications is to be executed, or which application is to be placed priority for execution. According to the cable broadcasting receiving device of the second embodiment, two service modes including a mode 1 (Auto Mode) and a mode 2 (Legacy Mode) shown in FIG. 9 are specified.

The mode 1 (Auto Mode) specified for the cable broadcasting receiving device of the second embodiment is a mode in which an OCAP application is downloaded and executed if the OCAP service is offered, and the built-in application is executed if the OCAP service is not offered. Further, the mode 2 (Legacy Mode) is a mode in which an operation is carried out only by the built-in application without receiving the OCAP application regardless of whether or not the OCAP service is offered.

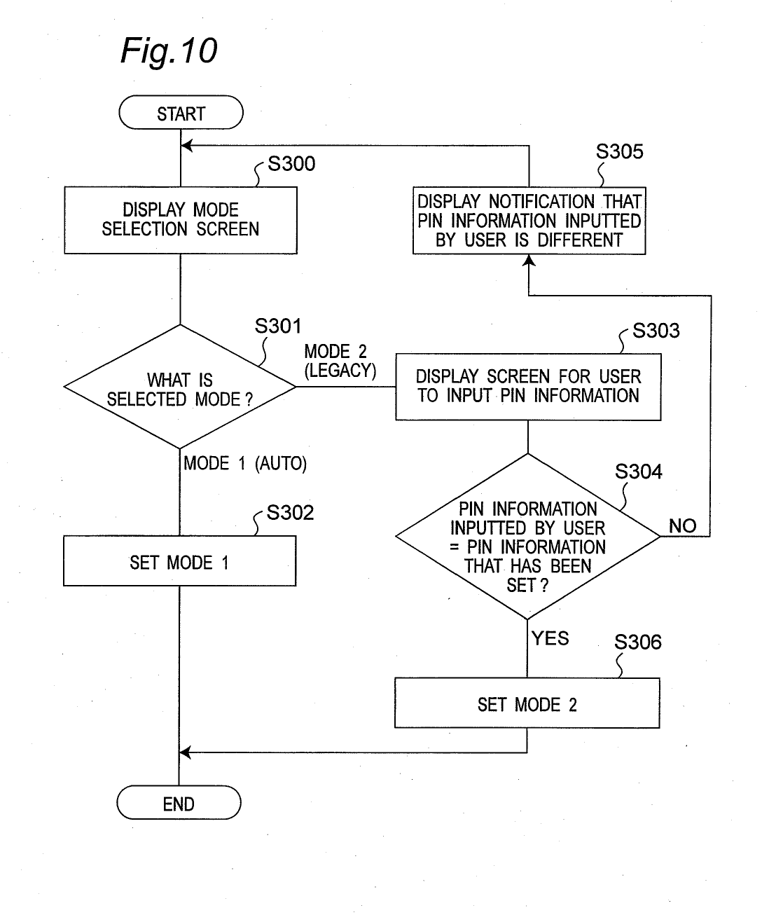

A description will be given of an operation when the user sets the service mode with reference to a flow chart of FIG. 10.

In step S300, a mode selection screen is displayed on the display. Specifically, the display screen can be any screen as long as it is possible for the user to select one of the service modes of the mode 1 (Auto Mode) and the mode 2 (Legacy Mode) shown in FIG. 9. In S301, it is determined whether the service mode selected by the user is the mode 1 (Auto Mode) or the mode 2 (Legacy Mode) (S301). If the service mode selected by the user is the mode 1 (Auto Mode), the mode 1 is set by the data management part 58 (S302). If the service mode selected by the user is the mode 2 (Legacy Mode), a screen that prompts the user to input PIN information is displayed on the display 11 in S303. It is confirmed whether or not the PIN information inputted by the user is identical with the PIN information for the OCAP application held in the data management part 58 (S304). If the PIN information inputted by the user is different from the PIN information for the OCAP application held in the data management part 58, a text such as “PIN number is not correct”, for example, is displayed (S305), and the screen to prompt the user to select the service mode is again displayed (proceeding to S300). If the PIN information inputted by the user is identical with the PIN information for the OCAP application held in the data management part 58, the mode 2 is set by the data management part 58 (S306).

When the user selects the mode 2 (Legacy Mode) in which the operation is carried out only by the built-in application without receiving the OCAP application regardless of whether or not the OCAP service is offered through the selecting operation of the service mode as described above, the service mode is changed after the PIN information for the OCAP application is confirmed. Therefore, in the cable broadcasting receiving device of the second embodiment, it is possible to set the service mode without impairing convenience to the user in a simple manner with consideration for the parental control function.

[Video Output Operation When Turning Power-on]

Next, provided that the service mode setting as described above has been done, an operation of the cable broadcasting receiving device 100 of the second embodiment after the power is turned on will be described. As the hardware configuration and the basic functional configuration of the cable broadcasting receiving device of the second embodiment are the same as shown in FIG. 1 and FIG. 6 described above regarding the cable broadcasting receiving device of the first embodiment, the same terms are used in the description.

The cable broadcasting receiving device of the second embodiment is a modified example where the selecting operation of the service mode described above is added to the power-on operation described with reference to FIG. 7 regarding the cable broadcasting receiving device of the first embodiment.

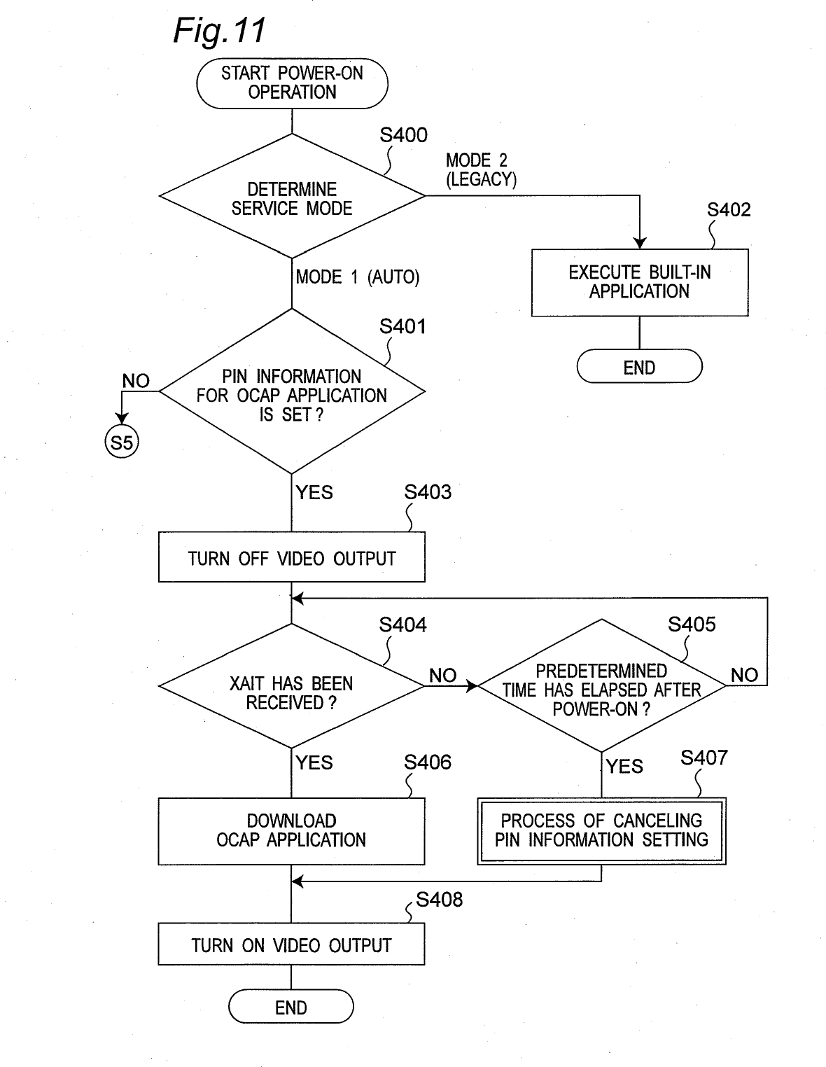

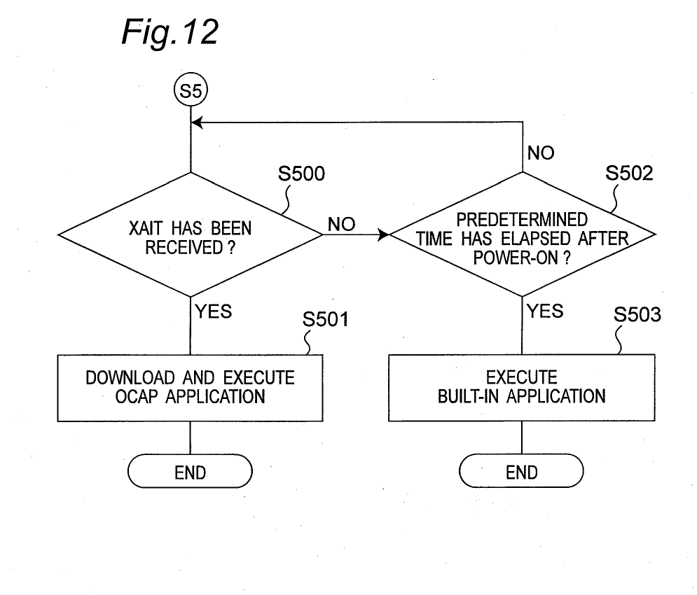

A description will be given of an operation of the cable broadcasting receiving device of the second embodiment after the power is turned on (on state) with reference to FIG. 11 and FIG. 12.

When the power is turned on, the service mode managed by the data management part 58 is confirmed (S400). If the service mode is the mode 2 (Legacy Mode), the built-in application is executed without receiving the OCAP application regardless of whether or not the OCAP service is offered. However, even in the case in which the OCAP application is not to be received, detection as to whether or not the XAIT has been received can be carried out, and a text “OCAP application is available”, for example, may be displayed when the XAIT has been received, (S402). As described above, as the service mode is modified after the confirmation of the PIN information for the OCAP application when setting the mode 2 (Legacy Mode), the built-in application is executed with consideration for the parental control function.

When the service mode is the mode 1 (Auto Mode) in S400, the process proceeds to step S401.

In step S401, it is confirmed whether the PIN information for the OCAP application is set or not by the data management part 58 (S401). If the PIN information is not set, the process proceeds to step S5. An operation of step S5 and thereafter will be later described with reference to FIG. 12. If the PIN information is set, the video output is turned to the off state (S403). Specifically, the plane for the built-in application is blacked out, and only the video output from the OSD plane is displayed (see FIG. 3A). Next, it is determined whether the XAIT has been received or not (S404). As described above, the XAIT is periodically distributed from the station server 200, and the fact that the XAIT has been received means that the cable broadcasting receiving device 100 can download the OCAP application and operate. On the other hand, when the XAIT cannot be received, it is confirmed, in S405, whether or not a predetermined time period has elapsed since the power-on (for example, 10 seconds).

If the predetermined time period has not elapsed, whether or not the XAIT has been received is again confirmed (proceeding to S404). If the XAIT cannot be received even after the predetermined time period has elapsed since the power-on, this means that an OCAP service is not offered. Accordingly, as the video output cannot be turned on in such a situation, the process of canceling the PIN information setting is carried out. Specifically, the canceling operation of the PIN information setting of FIG. 8 described above with reference to the first embodiment is carried out. Next, the description will be given with reference to FIG. 8.

In S200 of FIG. 8, a screen that prompts the user to input PIN information is displayed. It is confirmed whether or not the PIN information inputted by the user is identical with the PIN information for the OCAP application held in the data management part 58 (S201). If the PIN information inputted by the user is different from the PIN information for the OCAP application held in the data management part 58, a text such as “PIN number is not correct”, for example, is displayed (S202), and the screen to prompt the user to input PIN information is again displayed on the display 11 (proceeding to S200).

In S201, if the PIN information inputted by the user is identical with the PIN information for the OCAP application held in the data management part 58, the PIN information for the OCAP application stored in the data management part 58 is unlocked (S203). Along with the unlocking of the PIN information, the black out of the plane for the built-in application is also lifted (S204), and the video image is outputted (S204).

Referring back to the flow chart of the power-on operation shown in FIG. 11, when the XAIT has been received in S404, the OCAP application is downloaded (S406). As it takes more or less time to complete downloading the OCAP application, a text such as “Obtaining OCAP”, for example, is written to the OSD plane in consideration for the user, and a video image is outputted to the display 11. After the OCAP application is downloaded, the operation is carried out according to the OCAP application.

While the canceling of the PIN information setting of FIG. 8 is carried out in S407, a different process example is possible in which the user carries out the selecting operation of the service mode as shown in FIG. 10. When the XAIT cannot be received after the predetermined time period has elapsed since the power-on, it is apparent that the OCAP service is not offered, and therefore the operation of selecting the service mode as shown in FIG. 10 may be carried out instead of the canceling of the PIN information setting shown in FIG. 8. By letting the user to newly select the service mode in this manner, the selection of the application with consideration for the PIN information is carried out.

Next, the operation of step S5 and thereafter shown in FIG. 11 will be described with reference to FIG. 12.

As it is confirmed that the PIN information for the OCAP application has not been set in S401 of FIG. 11, it is determined whether or not the XAIT has been received in S500 of FIG. 12. As described above, the XAIT is periodically distributed from the station server 200, and the fact that the XAIT has been received means that the cable broadcasting receiving device 100 can download an OCAP application and operate. When the XAIT cannot be received, it is confirmed, in S502, whether or not a predetermined time period (for example, 10 seconds) has elapsed since the power-on (the power is in the on state).

If the predetermined time period has not elapsed since the power-on, the process proceeds to S500 to confirm again whether or not the XAIT has been received. If the XAIT cannot be received even after the predetermined time period has elapsed since the power-on, this means that an OCAP service is not offered, and the process proceeds to step S503 to execute the built-in application.

On the other hand, when the XAIT is received in S500, an OCAP application is downloaded and the downloaded OCAP application is executed (S501).

While the above description of the second embodiment describes an example in which the video output is controlled by causing the plane for the built-in application to be blacked out in when the PIN information for the OCAP application is set in the cable broadcasting receiving device, the video output may be controlled by such a manner that only the video image from the OSD plane is outputted and displayed without outputting the video images from the video plane and the still plane.

In this manner, if the PIN information for the OCAP application is set, the receiving device of the second embodiment offers convenience to the user in a simple manner with consideration for the parental control function by selecting the service mode, when the service of the OCAP application is suspended or when the user has moved to an area in which the service of the OCAP application is not offered, thereby allowing the desired application to be executed without fail.

### Third Embodiment

A cable broadcasting receiving device of a third embodiment according to the present invention will be described below. The cable broadcasting receiving device of the third embodiment is configured to carry out an operation with consideration for the parental control function when the power is turned on (when the power is turned to the on state) and when a cable card is inserted. A hardware configuration and a basic functional configuration of the cable broadcasting receiving device of the third embodiment are the same as shown in FIG. 1 and FIG. 6 described above with reference to the first embodiment, and like functions and components are represented by like numerals, and the description in the first embodiment applies to these functions and components.

[Operation When Inserting Cable Card After Power-on]

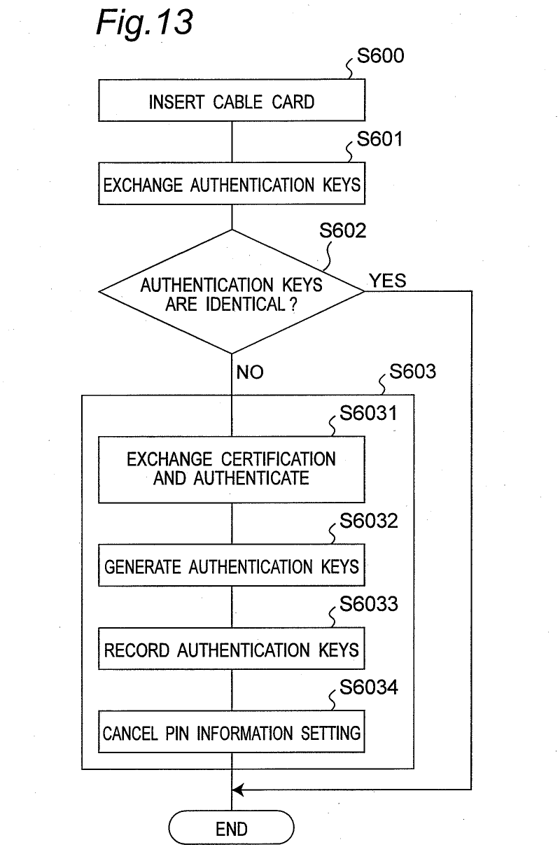

A description will be given of an operation when the cable card 300 is inserted after the power is turned on in the cable broadcasting receiving device of the third embodiment. The cable broadcasting receiving device of the third embodiment is characterized in a method of confirming the setting for the PIN information for the OCAP application when inserting the cable card 300, and canceling the PIN information setting if necessary. FIG. 13 is a flow chart showing the operation when the cable card 300 is inserted. In the following, the description will be given with reference to the flow chart of FIG. 13.

Upon insertion of the cable card 300 (S600), an authentication key managed by the cable card management part 59 and an authentication key recorded in a nonvolatile memory area of the cable card 300 are exchanged (S601).

If the authentication keys are identical to each other in S602, the process ends skipping a card authenticating operation in S603.

If the authentication keys are not identical to each other in S602, or if the authentication key is not set in the cable card management part 59, the card authenticating operation in S603 is carried out. In the card authenticating operation in S603, first, authentication between the cable card 300 and the cable broadcasting receiving device is carried out by mutually exchanging certification (S6031). After completing the authentication, the cable broadcasting receiving device and the cable card 300 each generate an authentication key based on IDs described in the exchanged certification respectively of the cable broadcasting receiving device and the cable card 300 (S6032). As a result, values of the authentication keys of the cable broadcasting receiving device and the cable card 300 become identical. The new authentication keys are recorded respectively in the nonvolatile memory area managed by the cable card management part 59 and a nonvolatile memory area of the cable card 300 (S6033). Further, the PIN information setting of the OCAP application set in the data management part 58 is cancelled (S6034), and thus a verification operation of the authentication key when the cable card 300 is inserted is completed.

The verification operation of the authentication key when the cable card 300 is inserted is as described above, and different authentication keys are generated every time when a different cable card 300 is inserted. Further, the cable card 300 is provided for the user from an operator of the cable television of the local area. When the user change the user's address to a different area, the cable card 300 that has been used is returned to the operator of the cable television of the area before moving out, and a new cable card 300 is provided from an operator of the cable television of the area of the new address.

In this manner, a different cable card is inserted to the cable broadcasting receiving device every time when the cable card 300 is first inserted after the user moves to a different area. Accordingly, with the cable broadcasting receiving device of the third embodiment, when a cable card is inserted after the address change, the PIN information setting of the OCAP application is cancelled without fail. In other words, the receiving device of the third embodiment is configured to, when the user inserts a different cable card, carry out the canceling of the PIN information setting in addition to the usual card authenticating operation. Therefore, with the receiving device of the third embodiment, if the PIN information for the OCAP application is set, the PIN information setting can be canceled by inserting the cable card when the service of the OCAP application is suspended or when the user has moved to an area in which the service of the OCAP application is not offered. Thus, the cable broadcasting receiving device of the third embodiment offers convenience to the user in a simple manner with consideration for the parental control function.

While the cable is used as a transmission medium of broadcasting data in the above description of the embodiments, a type of the transmission medium used for the present invention is not limited to the cable. The concept of the present invention relates to the receiving device that receives the broadcasting data, and can be applied to receiving devices whose functions can be realized both by the built-in application and the download application.

According to the description of each embodiment, a PIN information holding part described in the scope of the claims corresponds to the nonvolatile memory area managed by the data management part 58, and a PIN information setting cancellation part described in the scope of the claims has a function that is provided by the data management part 58. A function of a display control part described in the scope of the claims is realized by the CPU 10 and the plane management part 13. A mode selection part described in the scope of the claims has a function that is provided by the operational mode management part 55. A memory part described in the scope of the claims represents the memory means of the cable broadcasting receiving device of each embodiment, including the HDD 19, the memory 20, and the cache memory 21.

While the present invention has been described in certain detail with reference to the preferred embodiments, it should be understood that details in the configurations of these preferred embodiments currently disclosed can be altered, and the combinations of the components and their order can be modified without departing the scope and spirit of the present invention.

### INDUSTRIAL APPLICABILITY

The present invention relates to a receiving device that receives broadcasting data, and is useful for receiving devices such as TVs and STBs whose functions can be realized both by built-in applications and download applications.

1. A receiving device that receives digital broadcasting, the receiving device comprising:
a memory part that stores a download application obtained via a network and having a parental control function and a built-in application that is installed within the receiving device;
a PIN information holding part that holds PIN information with which the parental control function of the download application is set;
a display control part that, when PIN information with which the parental control function has been set is held in the PIN information holding part, sets a video output to an off state during a time period from power-on until a predetermined time elapses, and during which an operation is carried out based on the built-in application until the time when a download application can be received; and
a PIN information setting cancellation part that, when the PIN information with which the parental control function has been set is held in the PIN information holding part, cancels setting of the PIN information held in the PIN information holding part if a download application cannot be received during the time period from the power-on until the predetermined time elapses.

2. The receiving device according to claim 1, wherein
when the PIN information with which the parental control function has been set is held in the PIN information holding part and if a download application cannot be received during the time period from the power-on until the predetermined time elapses,
the display control part displays a screen for inputting PIN information, and
the PIN information setting cancellation part cancels the setting of the PIN information held in the PIN information holding part when PIN information that is identical with the PIN information held in the PIN information holding part is inputted.

3. A receiving device that receives digital broadcasting, the receiving device comprising:
a memory part that stores a download application obtained via a network and having a parental control function and a built-in application that is installed within the receiving device; and
a mode selection part that selects one of a first mode and a second mode, the first mode being a mode in which, when a download application can be received, the download application is received and executed, and, when a download application cannot be received, the built-in application is executed, and the second mode being a mode in which the built-in application is executed regardless of availability of a download application.

4. The receiving device according to claim 3, comprising:
a PIN information holding part that holds PIN information with which the parental control function of a download application is set, wherein
when the second mode has been selected, the mode selection part displays a screen for inputting PIN information, and sets the second mode when PIN information that is identical with the PIN information held in the PIN information holding part is inputted.

5. A receiving device that receives digital broadcasting, the receiving device comprising:
a memory part that stores a download application obtained via a network and having a parental control function and a built-in application that is installed within the receiving device;
a PIN information holding part that holds PIN information with which the parental control function of a download application is set;
a display control part that, when PIN information with which the parental control function has been set is held in the PIN information holding part, sets a video output to an off state during a time period from power-on until the time when a download application can be received during which an operation is carried out based on the built-in application;
a cable card interface part to which a cable card is detachably attached and that reads a content of a memory area of the cable card; and
a cable card management part that carries out an authenticating operation of the cable card, wherein
the cable card management part cancels, when the cable card is determined to be different from a cable card that has been authenticated last time in the authenticating operation, setting of the PIN information that is held in the PIN information holding part.

6. A receiving program stored in a receiving device that receives digital broadcasting, the receiving program causes a computer to realize:
a function for detecting, in a power-on operation, setting of PIN information with which a parental control function of a download application obtained via a network is set;
a function for, when the PIN information is set, setting a video output to an off state during a time period from the power-on until a predetermined time elapses until the time when a download application can be received;
a function for, when the PIN information is set and if a download application is received during the time period from the power-on until the predetermined time elapses, executing the download application; and
a function for canceling the setting of the PIN information when the PIN information is set and if a download application is not received during the time period from the power-on until the predetermined time elapses.

7. The receiving program according to claim 6, wherein
the function for canceling the setting of the PIN information includes:
a function for displaying a screen for inputting PIN information;
a function for verifying whether or not PIN information that is inputted is identical with PIN information that has previously been set;
a function for unlocking the PIN information if the inputted PIN information is identical with the PIN information that has previously been set, and turning the video output to an on state; and
a function for displaying the screen for inputting PIN information again if the inputted PIN information is different from the PIN information that has previously been set.

8. A receiving program stored in a receiving device that receives digital broadcasting, the receiving program causes a computer to realize:
a function for storing, in a memory part, a download application obtained via a network and having a parental control function and a built-in application that is installed within the receiving device;
a function for displaying a screen for selecting one of a first mode and a second mode,
the first mode being a mode in which, when a download application can be received, the download application is received and executed, and, when a download application cannot be received, the built-in application is executed, and
the second mode being a mode in which the built-in application is executed regardless whether a download application can be received or not;
a function for executing the first mode when the first mode has been selected;
a function for displaying a screen for inputting PIN information with which the parental control function of a download application is set when the second mode has been selected;
a function for verifying whether or not PIN information that is inputted is identical with PIN information that has previously been set;
a function for executing the second mode if the inputted PIN information is identical with the PIN information that has previously been set; and
a function for displaying the screen for selecting the mode again if the inputted PIN information is different from the PIN information that has previously been set.

9. A receiving program stored in a receiving device that receives digital broadcasting, the receiving program causes a computer to realize:
a function for storing, in a memory part, a download application obtained via a network and having a parental control function and a built-in application that is installed within the receiving device;
a function for managing one of a first mode and a second mode,
the first mode being a mode in which, when a download application can be received, the download application is received and executed, and, when a download application cannot be received, the built-in application is executed, and
the second mode being a mode in which the built-in application is executed regardless whether a download application can be received or not;
a function for detecting, in a power-on operation, setting of PIN information with which a parental control function of a download application is set when the first mode is managed;
a function for, when the PIN information is set, setting a video output to an off state during a time period from the power-on until a predetermined time elapses until the time when a download application can be received;
a function for, when the PIN information is set and if a download application is received during the time period from the power-on until the predetermined time elapses, executing the download application;
a function for canceling the setting of the PIN information when the PIN information is set and if a download application is not received during the time period from the power-on until the predetermined time elapses; and
a function for executing the built-in application when the second mode is managed in the power-on operation.

10. The receiving program according to claim 9, comprising:
when the first mode is managed in the power-on operation and when the PIN information for a download application is not set,
a function for, when a download application is received during the time period from the power-on until the predetermined time elapses, executing the download application; and
a function for executing the built-in application when a download application is not received during the time period from the power-on until the predetermined time elapses.

11. A receiving program stored in a receiving device that receives digital broadcasting, the receiving program causes a computer to realize:
a function for storing, in a memory part, a download application obtained via a network and having a parental control function and a built-in application that is installed within the receiving device;
a function for exchanging an authentication key managed in the receiving device and an authentication key recorded in a detachable card, and for detecting whether or not the authentication keys are identical to each other;
a function for exchanging certification of the receiving device and certification of the card and authenticating each other when the authentication key of the receiving device and the authentication key of the card are not identical;
a function for generating new authentication keys based on contents of both the certification of the receiving device and the card;
a function for recording the newly generated authentication keys respectively in corresponding memory areas of the receiving device and the card;
a function for canceling setting of PIN information with which the parental control function of the download application is set after the newly generated authentication keys are recorded in the receiving device and the card; and
a function for terminating an operation of authenticating the card by the receiving device when the authentication key of the receiving device and the authentication key of the card are identical and when the setting of PIN information is canceled.
